(19) United States
(12) Patent Application Publication
(10) Pub. No.: US 2005/0071336 A1
(43) Pub. Date: Mar. 31, 2005

(54) Systems and methods for logging and recovering updates to data structures

(75) Inventors: Marc A. Najork, Palo Alto, CA (US); Chandramohan A. Thekkath, Palo Alto, CA (US); Lidong Zhou, Sunnyvale, CA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/674,676

(22) Filed: Sep. 30, 2003

(51) Int. Cl. G06F 7/00

(52) U.S. Cl. 707/8

(57) ABSTRACT

Systems and methods for logging and recovering updates to data structures in the event of failure of an information management system are provided. In exemplary implementations, methods for implementing an efficient redo log for a data structure that is concurrently accessed by multiple clients is provided. The data structure is implemented in two layers: the data structure algorithm layer which sits atop an allocator that provides distributed, persistent, and replicated storage allocation. Both the B-link tree algorithm layer and the allocator use the service of the logging mechanism to implement fault-tolerance and atomicity guarantees. The present invention uses a single log and allows periodic truncation of that log for space efficiency.

### CROSS REFERENCE TO RELATED APPLICATIONS

The present application is generally related by subject matter to copending application Ser. No. 10/308,293 (attorney docket MSFT-1411/301600.1), entitled “Algorithm for Tree Traversals Using Left Links” and to copending application Ser. No. 10/308,291 (attorney docket MSFT-1410/301,252.1), entitled “Deletion and Compaction Using Versioned Nodes,” both filed on Dec. 2, 2002.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2002-2003, Microsoft Corp.

### FIELD OF THE INVENTION

This invention relates to the logging and recovery of data structures used in the field of data management. More particularly, the invention relates to the logging and (post failure) recovery of updates to data structures, such as B-trees and B-link trees.

### BACKGROUND

Data structures, such as B-trees, B-link trees, B*trees, B+ trees, etc., are a core technology to relational and non-relational databases, as well as to file systems and other systems in which a data structure including a set of linked nodes is employed as a way to index and access large amounts of data. A database management system is one example of an information management/retrieval system of the kind for which the present invention is suited. Since the present invention is well suited for use in connection with a database, although by no means limited thereto, the background of the invention and exemplary embodiments are discussed with reference to a database.

A B-link tree is a data structure that maintains an association of “keys” (such as employee numbers) to “values” (such as employee records). A B-link tree is a variant of a B-tree, typically stored on disk, which is at the foundation of relational database systems. B-link trees are particularly well suited to distributed and fault-tolerant implementations. Further background information about linked data structures, such as B-trees and B-link trees, may be found in the following documents:
1. R. Bayer and E. McCreight. Organization and Maintenance of Large Ordered Indexes. Acta Informatica, 1(3):173-189, 1972.
2. D. Corner. The Ubiquitous B-Tree. ACM Computing Surveys, 11(2):121-128, June 1979.
3. P. L. Lehman and S. B. Yao. Efficient Locking for Concurrent Operations on B-Trees. ACM Transactions on Information retrieval systems, 6(4):650-670, December 1981.
4. Yehoshua Sagiv. Concurrent Operations on B-Trees with Overtaking. Journal of Computer and System Sciences, Vol. 3, No. 2, October 1986.
5. Paul Wang. An In-Depth Analysis of Concurrent B-Tree Algorithms. Technical report MIT/LCS/TR496, Laboratory for Computer Science, Massachusetts Institute of Technology, Feb. 1991.
6. H. Wedekind. On the selection of access paths in an information retrieval system. In J. W. Klimbie and K. L. Koffman, editors. Database Management, pages 385-397. North Holland Publishing Company, 1974.

Efficient implementations of such distributed data structures are of strategic importance to companies wishing to deploy scalable storage repositories, e.g., file systems, databases and general indexes. Distributing relations over multiple machines makes it possible to build scalable databases, where the size of the database can be increased simply by adding more hardware. Providing reliability guarantees of the data in B-link trees in the presence of hardware (e.g., disk, network, and machine) failures and in the presence of concurrent updates is crucial for any realistic use of these data structures. The existing art describing techniques relating to B-trees and B-link trees, however, does not deal specifically with logging and recovery of a distributed data structure in the presence of potentially concurrent update operations.

Information retrieval systems typically support concurrent access to and updating of the data maintained by them, which means that there may be multiple concurrent lookup and/or update operations on the underlying B-tree. In order to prevent these concurrent operations from corrupting the B-tree, some synchronization scheme is required. Thus, one way to handle concurrent updates of a B-tree is to order traversal of and operations on the tree according to predetermined rules when updating or modifying the tree. Typical concurrent B-tree algorithms synchronize concurrent operations at the node-level of the tree; that is, an operation that wants to modify a node of the tree has to acquire a lock on that node, in order to guarantee that it does not interfere with another concurrent update (or other) operation on the same node.

Lock acquisition is expensive in several respects: It can be computationally expensive, especially when the B-tree is replicated, or distributed, across multiple computers, meaning that locks have to be acquired from a remote lock server, and it limits concurrency. Thus, there are a number of existing efforts to minimize the number of lock acquisitions without compromising the correctness of the algorithm. Much research has been devoted to this topic. For example, Paul Wang, An In-Depth Analysis of Concurrent B-Tree Algorithms, cited above, contains a good survey of work on this problem. Thus, applying algorithms to concurrent B-trees with minimal locking is one way of building distributed databases, where a single relation may span multiple machines. A B-Tree algorithm that is sometimes used with respect to minimizing lock acquisitions when traversing a tree is the Sagiv algorithm (see Yehoshua Sagiv, Concurrent Operations on B-Trees with Overtaking, cited above). However, Sagiv's algorithm is imperfect in at least two respects: First, with Sagiv's algorithms, operations may get “lost” while trying to locate a data record and have to be restarted. Second, Sagiv's algorithm requires additional lock acquisitions when garbage-collecting deleted nodes. The systems and methods described in commonly assigned copending U.S. patent application Ser. Nos. 10/308,291 and 10/308,293 improve upon the Sagiv algorithm in various ways.

Nevertheless, while an extensive body of prior art focuses on how to traverse a tree and when to acquire a lock on a node when updating the tree in order to ensure reliability when recovering from failure, to date, no currently existing work focuses on the problems associated with logging and recovering updates to a significantly scalable distributed data structure after failure of the system in the presence of concurrent updates. In essence, no one has focused on optimizing logging in connection with a distributed data structure. Accordingly, there is a great need in the art for improved logging in connection with distributed data structures to ensure reliability and scalability of the underlying system in the presence of concurrent updates.

### SUMMARY OF THE INVENTION

In consideration of the above-identified shortcomings of the art, the present invention provides systems and methods for logging and recovering updates to data structures in the event of failure of an information management system. The invention is a method for implementing an efficient redo log for a B-link tree data structure that is concurrently accessed by multiple clients. The B-link tree data structure is implemented in two layers: the B-link tree algorithm layer which sits atop an allocator that provides distributed, persistent, and replicated storage allocation. Both the B-link tree algorithm layer and the allocator use the service of the logging mechanism to implement fault-tolerance and atomicity guarantees. The present invention uses a single log and allows periodic truncation of that log for space efficiency.

Other advantages and features of the invention are described below.

### BRIEF DESCRIPTION OF THE DRAWINGS

The systems and methods for logging and recovering updates to data structures in accordance with the present invention are further described with reference to the accompanying drawings in which:

FIG. 1A is a block diagram representing an exemplary network environment having a variety of computing devices in which the present invention may be implemented;

FIG. 1B is a block diagram representing an exemplary non-limiting computing device in which the present invention may be implemented;

FIGS. 2A and 2B describe some exemplary aspects of exemplary distributed data structures, such as B-trees and B-link trees, utilized in connection with exemplary embodiments of the invention;

FIGS. 3A to 3F illustrate exemplary aspects of the derivation of the present invention in accordance with optimal requirements of a logging and recovery system; and

FIG. 4 illustrates an exemplary handling of data replication built into embodiments of the invention.

### DETAILED DESCRIPTION OF THE INVENTION

Overview

As mentioned, no currently existing work focuses on the problems associated with logging and recovering updates to a significantly scalable data structure after failure of the system in the presence of concurrent updates. In essence, no one has focused on optimizing logging in connection with a distributed data structure. While prior art systems have effectively provided an infinite log by archiving logging data when the log becomes full, the invention presents a solution with a single finite log that can be used in the event of failure of an information management system. The invention is a method for implementing an efficient redo log for a B-link tree data structure that may be distributed across multiple machines and is concurrently accessed by multiple clients. The B-link tree data structure is implemented in two layers: the B-link tree algorithm layer and an allocator layer. Both the B-link tree algorithm layer and the allocator use the service of the logging mechanism to implement fault-tolerance and atomicity guarantees. The present invention uses a single log and allows periodic truncation of that log for space efficiency.

Exemplary Networked and Distributed Environments

One of ordinary skill in the art can appreciate that the invention can be implemented in connection with any computer or other client or server device, which can be deployed as part of a computer network, or in a distributed computing environment. In this regard, the present invention pertains to any computer system or environment having any number of memory or storage units, and any number of applications and processes occurring across any number of storage units or volumes, which may be used in connection with processes for logging and recovering updates in accordance with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services. Ensuring reliability and scalability of a distributed data structure is particularly relevant to those computing devices operating in a network or distributed computing environment, and thus the techniques for logging and recovering updates in accordance with the present invention can be applied with great efficacy in those environments.

Distributed computing facilitates sharing of computer resources and services by exchange between computing devices and systems. These resources and services include, but are not limited to, the exchange of information, cache storage, and disk storage for files. Distributed computing takes advantage of network connectivity, allowing clients to leverage their collective power to benefit the entire enterprise. In this regard, a variety of devices may have applications, objects or resources that may implicate processing performed in connection with the logging and recovering of updates in accordance with the invention.

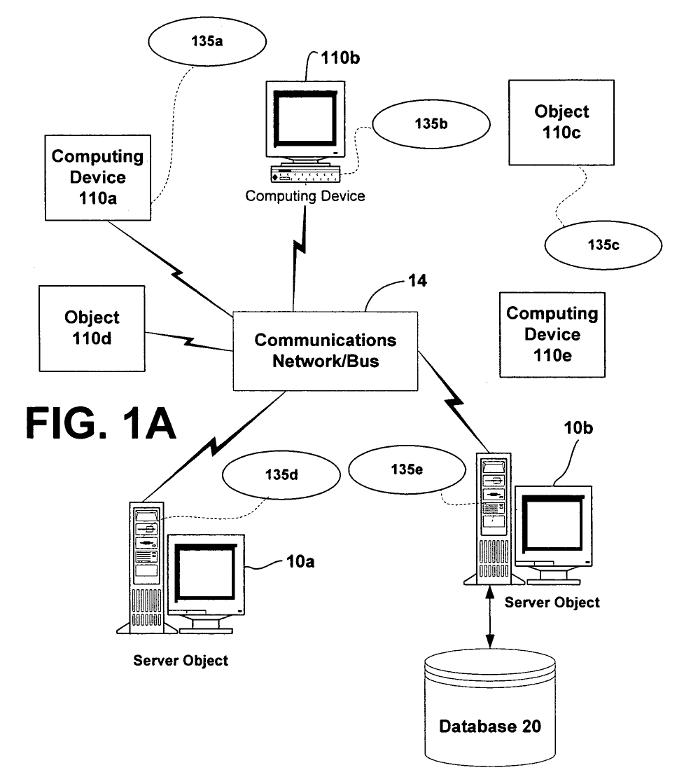

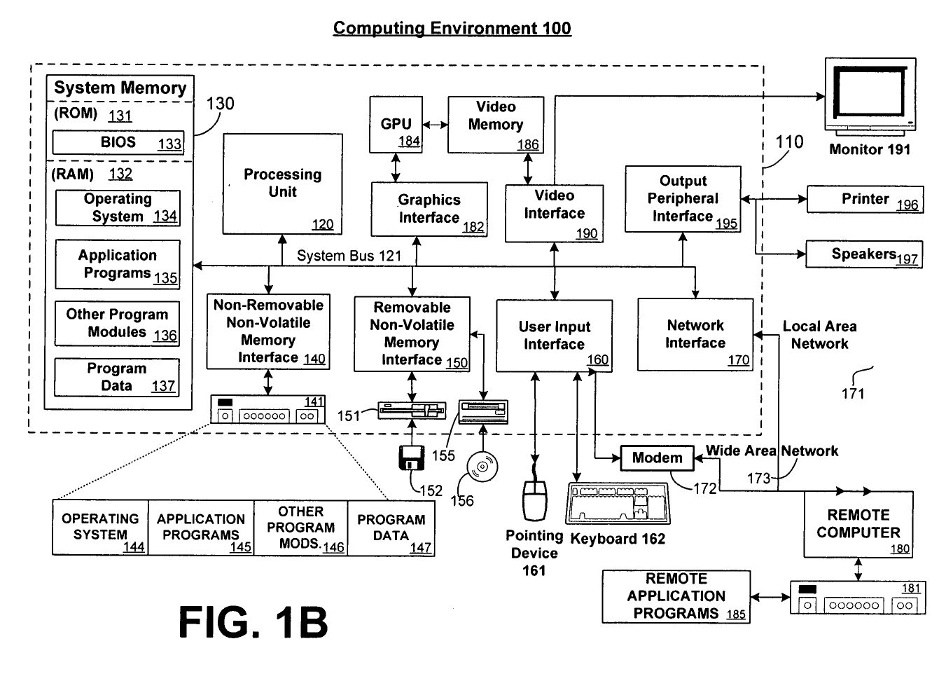

FIG. 1A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, personal computers, etc. Each object can communicate with another object by way of the communications network 14. This network may itself comprise other computing objects and computing devices that provide services to the system of FIG. 1A, and may itself represent multiple interconnected networks. In accordance with an aspect of the invention, each object 10a, 10b, etc. or 110a, 110b, 110c, etc. may contain an application that might make use of an API, or other object, software, firmware and/or hardware, to request use of the processes used to implement the logging and recovering of updates in accordance with the invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks. Any of the infrastructures may be used for exemplary communications made incident to logging and recovering updates in accordance with the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge as protocol standards may be interconnected to form a network, such as an intranet, that may be connected to the outside world by way of the Internet. In short, a variety of disparate sources exist for the storage and transmission of data, and consequently, moving forward, computing devices will require ways of sharing data, such as data in a distributed data structure, or data accessed by, generated by or utilized incident to program objects, which make use of or implement the logging and recovery of updates in accordance with the present invention.

The Internet commonly refers to the collection of networks and gateways that utilize the TCP/IP suite of protocols, which are well-known in the art of computer networking. TCP/IP is an acronym for “Transmission Control Protocol/Internet Protocol.” The Internet can be described as a system of geographically distributed remote computer networks interconnected by computers executing networking protocols that allow users to interact and share information over the network(s). Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 1A, computers 110a, 110b, etc. can be thought of as clients and computer 10a, 10b, etc. can be thought of as servers where servers 10a, 10b, etc. maintain the data that is then replicated in the client computers 110a, 110b, etc., although any computer could be considered a client, a server, or both, depending on the circumstances. Any of these computing devices may be processing data, such as data from a distributed data structure, or requesting services or tasks that may implicate the logging techniques of the invention.

A server is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the logging and recovery of updates in accordance with the invention may be distributed across multiple computing devices or objects.

Client(s) and server(s) communicate with one another utilizing the functionality provided by a protocol layer. For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over any available communications medium.

Thus, FIG. 1A illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to maintain a distributed data structure.

In a network environment in which the communications network/bus 14 is the Internet, for example, the servers 10a, 10b, etc. can be servers with which the clients 110a, 110b, 110c, 110d, 10e, etc. communicate via any of a number of known protocols such as HTTP. Servers 10a, 10b, etc. may also serve as clients 110a, 110b, 110c, 110d, 110e, etc., as may be characteristic of a distributed computing environment.

Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files or data streams may be stored or to which portion(s) of files or data streams may be downloaded, transmitted or migrated. Any computer 10a, 10b, 110a, 110b, etc. may be responsible for the maintenance and updating of a database, memory, or other storage element 20 for storing data processed according to the invention. In this regard, a distributed data structure may be stored across a plurality of databases 20. Thus, the present invention can be utilized in a computer network environment having client computers 110a, 1110b, etc. that can access and interact with a computer network/bus 14 and server computers 10a, 10b, etc. that may interact with client computers 110a, 1110b, etc. and other like devices, and databases 20.

Exemplary Computing Device

FIG. 1B and the following discussion are intended to provide a brief general description of a suitable computing environment in connection with which the invention may be implemented. It should be understood, however, that handheld, portable and other computing devices and computing objects of all kinds are contemplated for use in connection with the present invention, i.e., anywhere from which data may be generated, processed, received and/or transmitted in connection with one or more distributed data structures in a computing environment. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the logging and recovery techniques in accordance with the invention.

Although not required, the invention can be implemented via an operating system, for use by a developer of services for a device or object, and/or included within application or server software that operates in connection with the logging and recovery techniques in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 1B thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1B illustrates operating system 134, application programs 135, other program modules 136, and program data 137.

The computer 110 may also include other removable/non-removable, volatile/nonvolatile computer storage media. By way of example only, FIG. 1B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1B provide storage of computer readable instructions, data structures, program modules and other data for the computer 110. In FIG. 1B, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the application variables of the invention may have impact. GPUs 184, however, are but one example of a coprocessor and thus a variety of coprocessing devices may be included in computer 110, and may include a variety of procedural shaders, such as pixel and vertex shaders. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1B. The logical connections depicted in FIG. 1B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1B illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web sites, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software residing on a computing device, one or more portions of the invention may also be implemented via an operating system, application programming interface (API) or a “middle man” object, a control object, hardware, firmware, intermediate language instructions or objects, etc., such that the methods for logging and recovery techniques of the invention may be included in, supported in or accessed via all of the languages and services enabled by managed code, such as .NET code, and in other distributed computing frameworks as well.

Overview—Exemplary B-Tree Data Structures and Operations

Initially, to set forth an exemplary non-limiting context in which the present invention may be implemented, an overview of an exemplary distributed data structure and the operations that are typically performed on the data structure are presented.

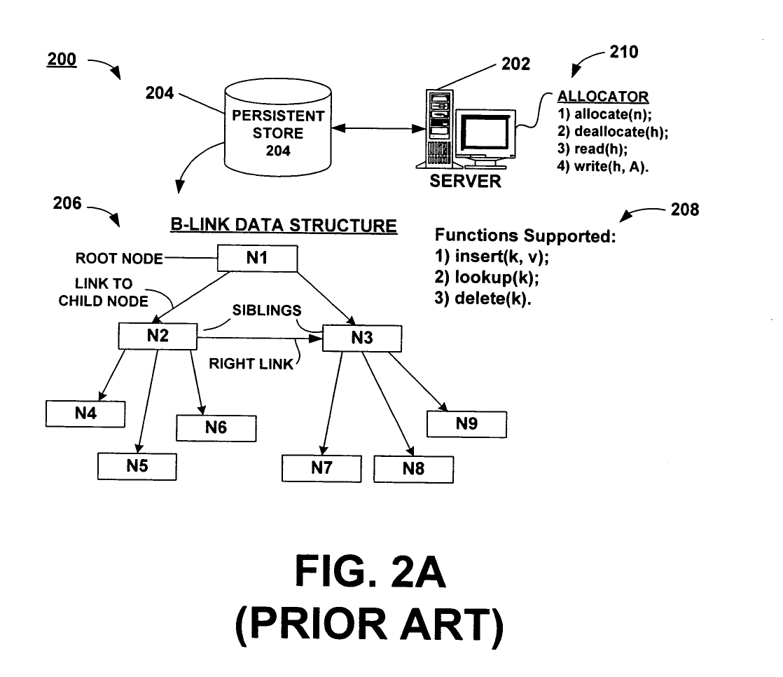

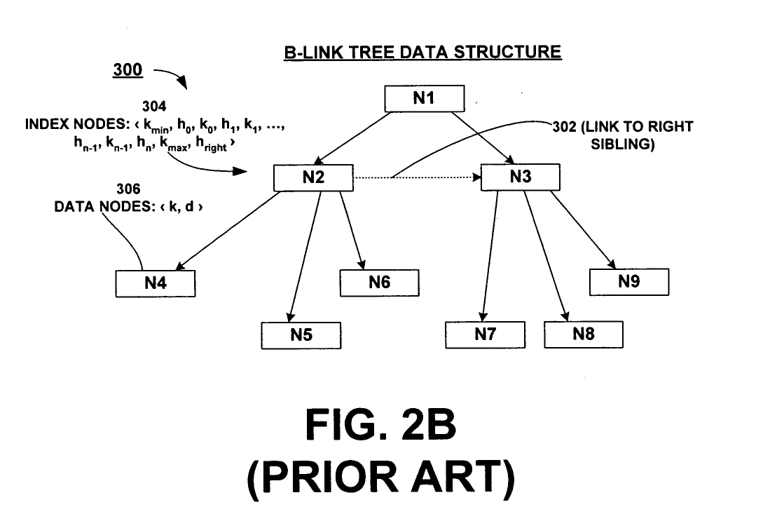

FIG. 2A depicts a typical information retrieval system 200. As shown, such a system can include a server 202 and a persistent store 204, such as a database. In addition, the data residing in the store 204 may be organized in the form of a tree, e.g., a B-link tree 206. Such a data structure includes nodes, N1, N2, N3 and so on, and, in the case of index nodes, links from each node to at least one other node (data nodes typically have only incoming links). The nodes may be sized to correspond to a disk block, or may be bigger or smaller, and may be formed as data nodes and index nodes (discussed further below in connection with FIG. 2B). Further, there is a root node (node N1 in FIG. 2A) and children nodes, with sibling nodes being those nodes that have a common parent (e.g., nodes N2 and N3 are siblings). Index nodes may also be linked to their right siblings, as shown.

A B-Tree is a data structure that maintains an association of keys with values. A prerequisite is that there exists a total ordering over the keys, i.e., that it is always possible to decide whether one key is larger than the other. As indicated in FIG. 2A, reference number 208, B-trees support three basic operations:
1) insert(k, v), which associates the key k with the value v;
2) lookup(k), which returns the value v associated with the key k; and
3) delete(k), which disassociates the key k from its associated value.

B-trees were first described by Bayer and McCreight (R. Bayer and E. McCreight, Organization and Maintenance of Large Ordered Indexes, cited above). There are many variations of B-Trees, including B*-trees (see H. Wedekind, On the selection of access paths in an information retrieval system, cited above), B+-Trees (see D. Comer, The Ubiquitous B-Tree, ACM Computing Surveys, cited above), and B-Link Trees (see P. L. Lehman and S. B. Yao, Efficient Locking for Concurrent Operations on B-Trees, cited above). The present invention is applicable to all types of B-Trees and variations thereof, and the term B-tree as used herein in describing the invention is intended to encompass all variants of the basic B-tree structure.

A B-tree stores keys and values as well as metadata in nodes. Nodes are kept on disk or some other storage device (B-Trees make sense for any slow and cheap storage device), and are read into main memory on demand, and written back to disk if modified. Nodes on disk are identified by handles. For the purpose of this discussion, it is sufficient to think of handles as the addresses of contiguous ranges of storage blocks (e.g., disk block addresses) plus optional metadata. As indicated in FIG. 2A, reference numeral 210, an allocator is a software component that maintains nodes on disk and supports four operations:
1) allocate(n), which reserves space on the disk for a node with a maximum size of n bytes and returns a handle to it;
2) deallocate(h), which relinquishes the space at the disk location identified by the handle h;
3) read(h), which reads the node from the disk location identified by the handle h and returns it; and
4) write(h, A), which writes the node A from main memory to the disk location identified by handle h.

Herein, it is assumed that allocator operations are atomic, that is, two concurrent operations on the same handle do not interfere with each other.

Nodes in a B-Tree may contain handles referring to other nodes. In most B-Tree variants, the handles connect the nodes to form a tree (hence the name), a directed, connected, and acyclic graph. It is noted that every tree is a directed acyclic graph, but not every directed acyclic graph is a tree. For instance, a B-Link Tree, discussed below, is a directed acyclic graph, but not a tree. In the following, the reader is assumed to be familiar with the definition of a tree and the terms subtree, link, root, leaf, parent, child, and sibling. B-Link Trees differ from proper trees in that in addition to the links from parents to children, every node has a link to its directly adjacent right sibling (if such a sibling exists). This can be seen in the exemplary B-Link Tree 300 of FIG. 2B, where the “right link” (link to right sibling) is represented by reference numeral 302.

A B-link tree can be thought of as composing two different kinds of nodes: data nodes and index nodes, reference numerals 304 and 306, respectively, of FIG. 2B. A data node is simply a key-value pair of the form <k,d>. An index node is of the form:
<kₘᵢₙ, h₀, k₁, h₁, k₁, . . . , hₙ₋₁, kₙ₋₁, kₙ, hₙ, kₘₐₓ, h_{right}>

In the following, we refer to field x of node A as A.x. Given an index node A, A.h₀ . . . A.hₙ are handles to the n+1 children of A, and A.h_{right}, is a handle to its right sibling. A.kᵢ (for 0≧i<n) is the largest key in the subtree rooted at handle A.hᵢ., and A.kᵢ₋₁ (or A.kₘᵢₙ if i=0) is less than the smallest key in the subtree rooted at handle A.hᵢ. A.kₘₐₓ is greater or equal to the largest key in any subtree of A (and per definition ∞if A does not have a right sibling), and A.kₘᵢₙ is equal to B.kₘₐₓ, where B is the left sibling of A (or −∞if A does not have a left sibling). Moreover, A.kₘᵢₙ<A.kₒ< . . . <A.kₙ≦kₘₐₓ. Finally, there is a limit on the size of n (which indicates the number of keys and handles in an index node). If n reaches a maximum value (say, 2t), then the index node is said to be full. Likewise, if n falls below a certain number (say, t), the node is said to be underfull.

Because of the constraints on the keys in an index node and the keys in the subtrees rooted at that node, B-Link trees are search trees, that is, trees where one can find a particular key by descending into the tree. Intuitively, lookup(k) starts at the root handle, reads in the corresponding node A, and identifies a value i such that A.kᵢ₋₁ (or A.kₘᵢₙ if i=0)<k≦A.kᵢ (or A.kₘₐₓ if i=n). It then recursively proceeds along the handle A.hᵢ until it reaches a data node B, and returns B's value if B's key is indeed k, or null otherwise.

The delete operation is similar to the lookup operation: delete(k) descends into the tree until a data node D with key k is discovered (if such a node exists). The operation then marks D as deleted (D is not immediately deallocated, because other ongoing operations may have a handle to D but not yet have read D), and removes the handle to D from D's parent node A. This may cause A to become underfull.

The insert operations is more complicated: insert(k,v) allocates a new data node D with handle h, writes the pair (k,v) to it, and then recursively descends into the tree the same way as lookup does, until it finds the leaf index node A (the index node whose children are data nodes) that should receive h. If A is not full, insert(k,v) simply inserts h and k at the appropriate places into A; otherwise, it allocates a new index node \overline{A}, moves half of A's key-handle pairs over to \overline{A}, inserts k and h into A or \overline{A}, and finally adds the handle to \overline{A} and A's new kₘₐₓ to A's parent (this may in turn cause A's parent to become overfull, causing the node splitting process to move up the tree).

As mentioned above, the delete operation may cause nodes to become underfull. To prevent too many nodes from becoming underfull (which would cause the tree to become deeper than it needs to be, which would increase the number of disk accesses required by each operation), a compression thread is run in the background. The thread repeatedly traverses the tree, searching for underfull nodes. When it locates an underfull node A, it either rebalances it with its left or right sibling (which entails moving key-handle pairs from the sibling to A, and adjusting a key in the parent node), or it outright merges A with its left or right sibling (which entails moving all of A's content to the sibling, marking A as deleted, and removing A's handle and corresponding key from A's parent, which in turn may cause the parent to become underfull).

Systems and Methods for Logging and Recovering Updates

As mentioned, building scalable databases, where the size of the database can be increased simply by adding more hardware is desirable. However, when more and more hardware is added to an information management system, the problems associated with reliability and recovery from a crash or failure of the hardware can become more acute.

Accordingly, the invention considers and optimizes how to log entries, or updates, to a data structure, such that in the event of a system failure, the state of the data structure can be recovered to the point of failure by resorting to the log. In this section, a derivation of the present invention is illustrated, and then exemplary embodiments for implementing the invention are presented.

The derivation of the present invention begins by analyzing the nature and requirements springing from the notions of an infinite persistent log, caching of data records and a finite log.

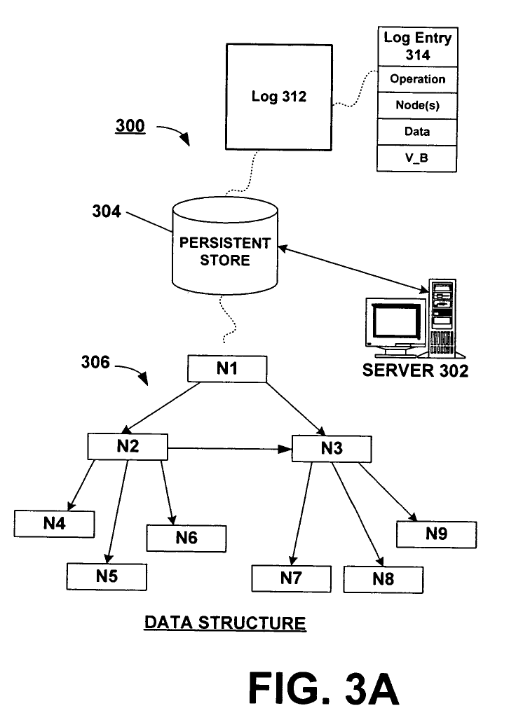

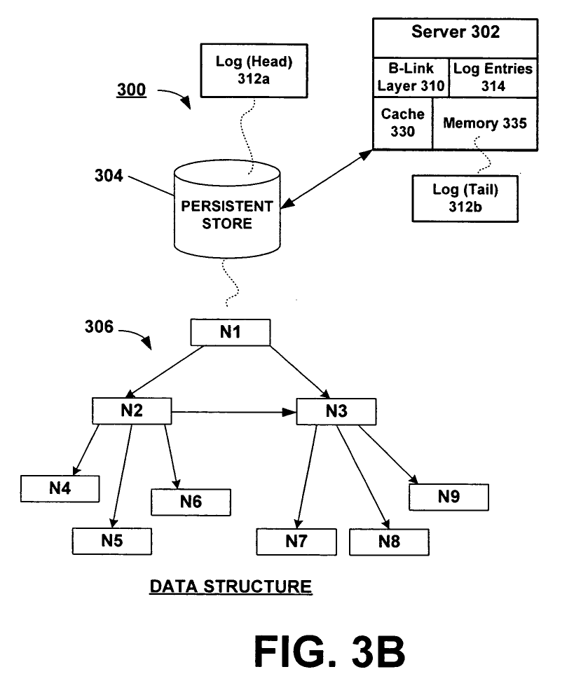

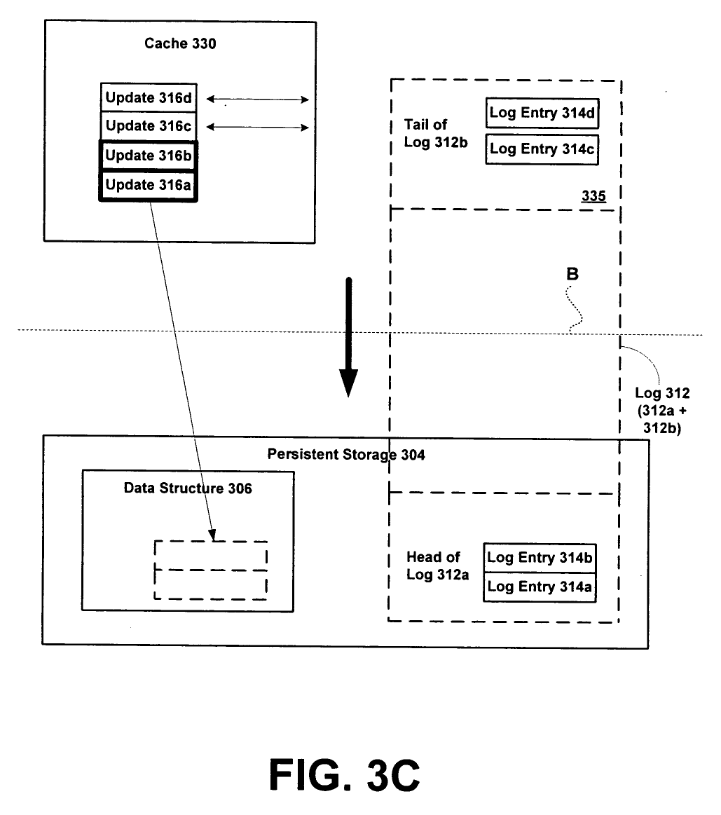

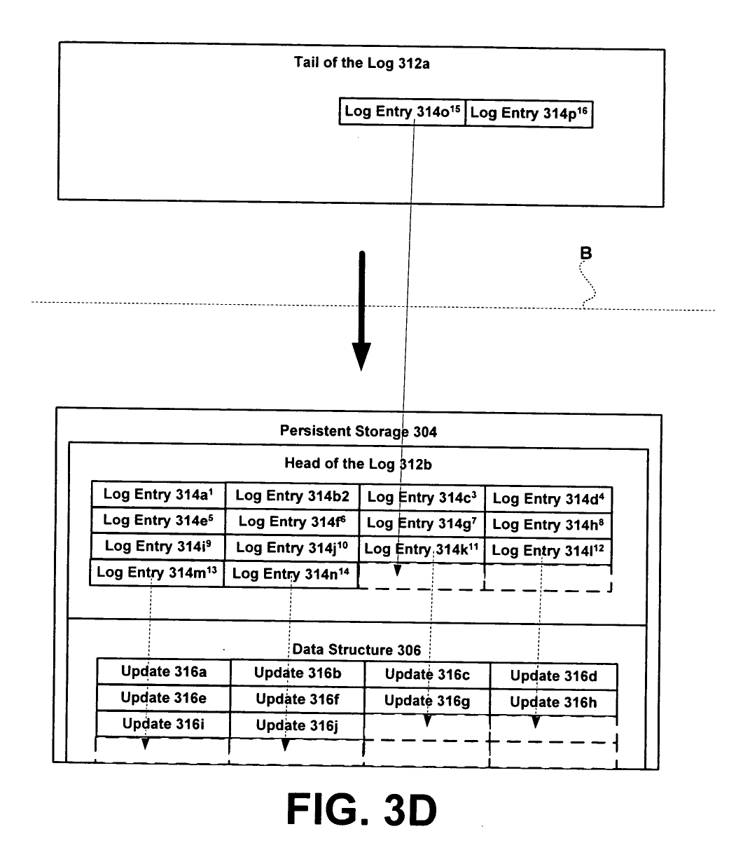

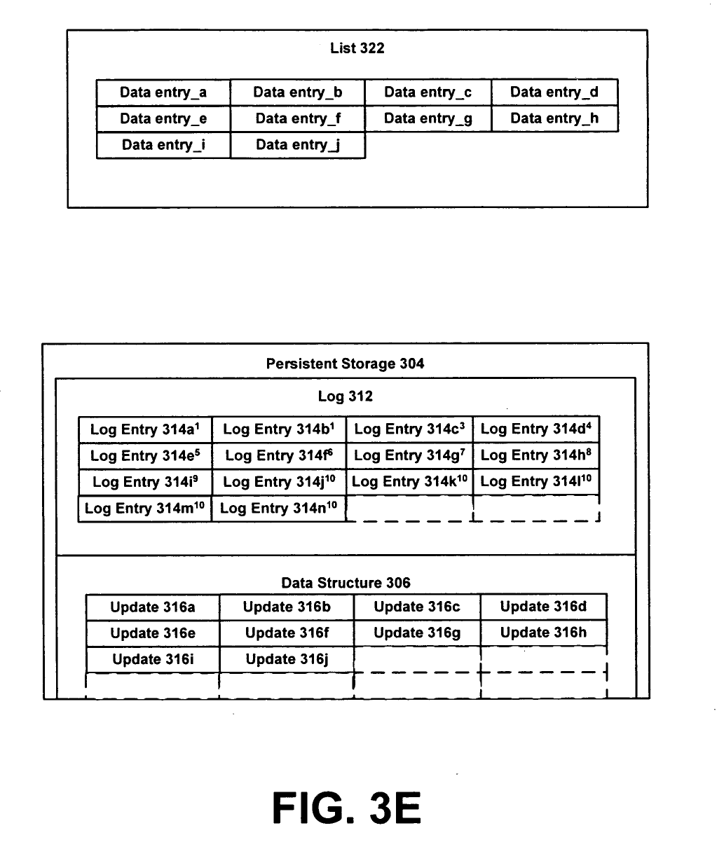

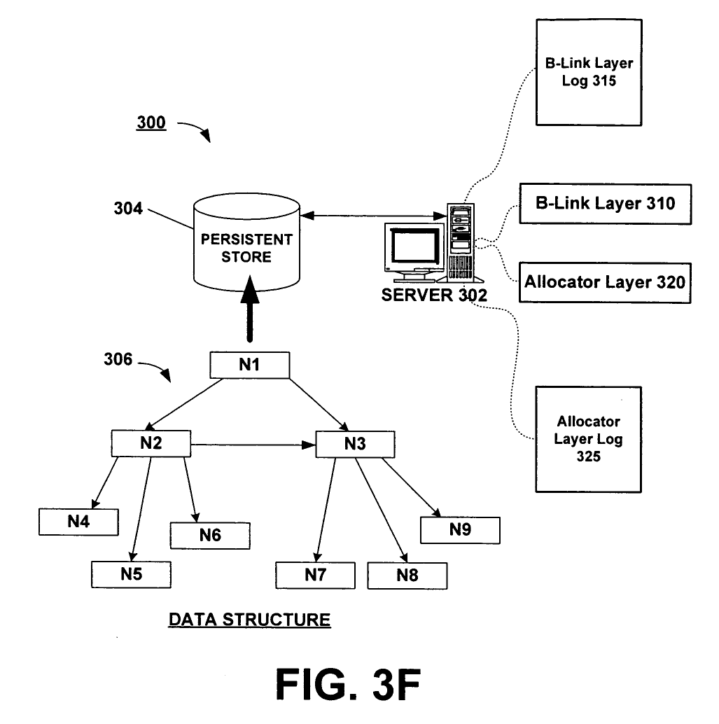

With respect to an infinite persistent log, logging for a single server is first considered. In this scenario, it is ideally assumed that an infinite persistent log is available, i.e., that a log exists that is persistent and has no bounds/memory constraints. FIG. 3A depicts an information retrieval system 300 that utilizes an infinite persistent log 312. As shown, such a system can include a server 302 and a persistent store 304, such as a database. In addition, the data residing in the store 304 may be organized the form of a tree, e.g., a B-link tree 306. Such a data structure includes nodes, N1, N2, N3 and so on, and, in the case of index nodes, links from each node to at least one other node. While log 312 is depicted as included in persistent store 304, log 312 could be provided in separate persistent storage.

In this case, a simple write-ahead redo log performs adequately. With a simple write-ahead redo log, before each (atomic) operation is carried out, a log entry for this operation is written to log 312 in the persistent storage 304. Such a log entry may include data identifying the operation to be performed on the data structure 306, the node(s) affected by the operation and possibly the data to be applied (if adding or modifying data). To recover the state of the server from the log after server failure, assuming that each operation is idempotent, the recovery process involves simply going through the log and re-applying the operations in the same order.

If not all operations are idempotent, then a version number can be associated with each piece of data. A log entry, such as log entry 314, in addition to recording information about the operation to be performed on the data structure 306, records V_B, the version number of the data before the operation. Then, an operation is re-applied during recovery only if the version number of the data on disk matches that of the version number before the operation recorded in the log. This ensures that an operation is never applied more than once. It is noted that, for this simple write-ahead redo log to work, the operation being logged must be atomic; that is, a failure will not leave the system in an intermediate state that is neither the state before the operation nor the state after.

This leads to the conclusion that effective and reliable logging (and recovery) in an information management system has a first requirement—(1) Before the result of an operation is committed to persistent storage, the log entry corresponding to that operation must be written to the log.

With respect to caching, FIG. 3B depicts another embodiment of information retrieval system 300. In a typical implementation, server 302 (which may comprise multiple computing devices) includes a B-link tree layer 310 generating log entries 314, a memory 335 and cache memory 330, which raises the question of how to log the operations of the B-link tree layer 310, some of which may be present in cache memory 330 as an intermediate step, i.e., how to handle log entries 314 describing data transactions to be performed on data structure 306 in such a system. Described in more detail below, one way to handle logging is to utilize memory 335 to stores log entries 314 that are not yet committed to persistent storage 304 while utilizing cache memory 330 to store updated records of data structure 306 as an intermediate step before commission to persistent storage 304.

Performance is improved in such a system because not all updates from the B-link tree layer 310 need go directly to persistent storage 304 as changes to data structure 306. Thus, as illustrated in FIG. 3B, if the operations are organized in transactions, the log record updates corresponding to a transaction are written to the persistent storage 304 when the corresponding transaction commits. In the meantime, they can be cached in cache storage 330.

Similarly, while a log entry 314 is generated for each operation by B-link layer 310, the log entry 314 does not need to be written to the persistent storage 304 immediately, and thus, a tail 312b of the log can be stored in memory 335 as an intermediate step. Memory 335, in a typical non-limiting implementation, comprises volatile storage. It follows from the first requirement formulated in connection with a theoretically existing infinite persistent log, however, that a log entry 314 must be written to persistent storage 304 before the changes (e.g., update 316) corresponding to a log entry 314 are reflected in the persistent storage 304. For example, as shown in FIG. 3C wherein memory 335 comprises volatile storage, log entries 314a and 314b, corresponding to updates 316a and 316b, respectively, have been written to the head of the log 312a in persistent storage before updates 316a and 316b have been committed as changes to data structure 306. Accordingly, at any time thereafter, updates 316a and 316b from cache 330 can be committed to data structure 306 in persistent storage 304.

This observation leads to the construction of a partially persistent log, where the tail of the log 312b is in memory 335. The boundary B between the persistent part of the log (e.g., in persistent storage 304) and the in-memory log changes over time as the entries 314 in the in-memory log are written to the persistent storage 304.

One way to ensure that this data block caching scheme works is to keep track of the log entry corresponding to the last update on a data block so that before the updates to the data block are committed to the disk, the log entries must be written out first. In various embodiments, this can be done by maintaining, with each cache entry, a LSN (log sequence number) corresponding to the log entry for the last update. LSNs uniquely identify log entries. This is illustrated in FIG. 3D, wherein the LSN numbers for a series of log entries 314a to 314p are written in superscript. The last update committed to disk is update 316j corresponding to log entry 314j (having LSN 10). Subsequent log entries are assigned the next LSN in the sequence. Before a cache entry with LSN number K is written to persistent storage, all log entries in the volatile portion of the log with LSN values less than or equal to K must be written to disk first.

In reality, logs are not infinite, i.e., memory constraints bound the size of real world logs. Thus, eventually when the log does wrap around, some log entries will be discarded to make room for new entries. To maintain correctness, the system must make sure that log entries that are discarded are useless.

By definition, log entries become useless when the corresponding updates to the data have been committed to persistent storage since after that the log entries are no longer needed during a recovery process. So, if the system finds no space available on the log when intending to write a new log entry into the log, then the system tries to eliminate log entries from the head of the log.

For each log entry to be discarded, the system checks whether the corresponding updates have been committed to the persistent storage. If not, the corresponding cache entry will have to be flushed to the persistent storage first. For this scheme to work, for each log entry, a list is recorded of data entries (each identified by a handle) that have been updated by the operations corresponding to the log entries. Thus, for example, in FIG. 3E, list 322 includes handles to the data entries that have been updated by the operations of the log entries.

This leads to an observation for a second requirement—(2) A log entry can be discarded from the log-if and only if the changes made by the corresponding operation have been committed to the disk.

It is noted that flushing the cache could also cause some in-memory log entries to commit to the persistent storage (to satisfy the first requirement) because the data in the cache could have been updated by later operations whose logs are still in the memory. This could in turn require more space in the already full log.

There are two approaches to break the circularity: reservation and log flush. With reservation, the system can always reserve enough space on the disk for the log entries in memory. This way, the log-flush will not lead to insufficient space on the log. With log flush, before generating a new log for an operation, the system flushes all existing in-memory log entries to the disk. The second option is inefficient because it defeats the whole purpose of having logs in memory. So, the first option is more desirable.

Further complication arises if the system supports transactions that each consists of a sequence of atomic operations (each with a corresponding log entry.) For instance, an insert operation into a B-tree may have to perform several atomic operations, e.g., splitting several nodes and inserting data. When recovering from failure, an incomplete transaction might need to be undone. Thus, no log entries for a transaction can be discarded from the log before the transaction is complete. This leads to a third requirement—(3) All log entries of a transaction must remain in the log until the transaction is committed or aborted.

Consistent with the above-described requirements of logging systems, various embodiments of the invention are now described. FIG. 3F depicts an information retrieval system 300. As shown, such a system can include a server 302 and a persistent store 304, such as a database. In many cases, the data residing in persistent store 304 is distributed and/or duplicated in a plurality of databases. In addition, the data residing in the store 304 may be organized the form of a tree, e.g., a B-link tree 306. Such a data structure includes nodes, N1, N2, N3 and so on, and, in the case of index nodes, links from each node to at least one other node. In a typical implementation, server 302 (which may comprise a plurality of computing devices) includes a B-link tree layer 310 and an allocation layer 320, which raises the question of how to log the operations of the B-link tree layer 310 and the allocation layer 320 so that examining the logging information after a failure enables unambiguous reconstruction of the data structure 306 to the appropriate point relating to the time of the failure.

A naïve implementation of the logging might resort to keeping two separate logs: a log 315 for the B-link tree layer 310 and a log 325 for allocation layer 320. However, in a large scale system, this leads to bad performance because two log writes (one to each log 315 and 325) must be performed. This involves positioning the actuator of a disk to a first position for the first log and then seeking and writing to a second position for the second log, and eventually re-seeking to the first position for the next logging operation. Thus, the present invention uses a single log and allows periodic truncation of that log for space efficiency. Unlike prior art B-tree or B-link tree systems, the invention coordinates the truncation of the log with periodic flushing of data to disk. The invention thus enables the maintenance of a small log, which translates to fast recovery.

In accordance with the present invention, server 302 includes a B-link tree layer 310 and an allocator layer 320. The B-link tree layer 310 handles B-link tree operations. The allocator layer 320 is in charge of allocating and de-allocating disk space, as well as reading from and writing to the allocated disk space, in response to B-link tree operations. While exemplary embodiments are described in connection with B-link trees, the invention may be applied to any data structure.

The logging of the invention ensures the atomicity of the B-link tree operations and facilitates fast recovery in case of failure. Because user-initiated B-link tree operations are not atomic, each B-link tree operation is treated as a transaction consisting of a sequence of atomic operations. For example, an insert operation for the B-link tree could not only cause a new data entry to be inserted, but could also lead to the split of one or more nodes along the path to the root. Manipulation of each single node will have a corresponding log record.

Even modifying a single node in a B-link tree might not be an atomic operation because the node can span multiple sectors on the disk. Usually, it can only be assumed that writing to a single sector is atomic. To make a multi-sector write atomic, the invention uses the following technique. The number of concurrent write operations to a disk are limited to a pre-fixed number. Then, an area on the disk large enough to hold the corresponding number of writes is reserved. A write spanning multiple sectors is first written to the reserved area and then to the actual sectors on disk. In this way, the invention enables recovery from a disk write failure at any point and the write appears atomic.

Furthermore, in accordance with the invention, allocation and de-allocation of disk space are logged at the allocator layer 320. Allocator layer 320 also maintains data structures for keeping track of disk allocation. Such information corresponds to the data being modified by allocation and deallocation operations, and therefore is written to the disk when the corresponding operations become persistent.

The insert and delete operations can be undone logically using a dual operation. For example, insertion of an entry can be undone by the deletion of that entry. However, a B-link tree insert operation requires multiple log records. Thus, the nature of the B-link tree insert operation is such that if a prefix of these log records is found, the insert operation can be logically completed. But when it is known that the operation did not complete, as evidenced by a partial prefix in the log, a logical undo of the insert operation is performed. The other B-link tree operation, i.e., delete, has only one log record, so the issue of a prefix does not arise.

Two classes of failures from which the invention may advantageously be used to recover include: (A) failure that does not include the failure of the disk medium (e.g., when the power goes off on a machine) and (B) failure that does include failure of the disk medium. Failure not including disk medium failure is addressed above by using a log as described in the various embodiments of the invention.

For failure involving media failure, however, merely logging data is not going to be adequate because the disk to which the log is being written could fail. So, to handle both types of failures (non-media failure and media failure), in one embodiment, the invention replicates the data and the log on independently failing components.

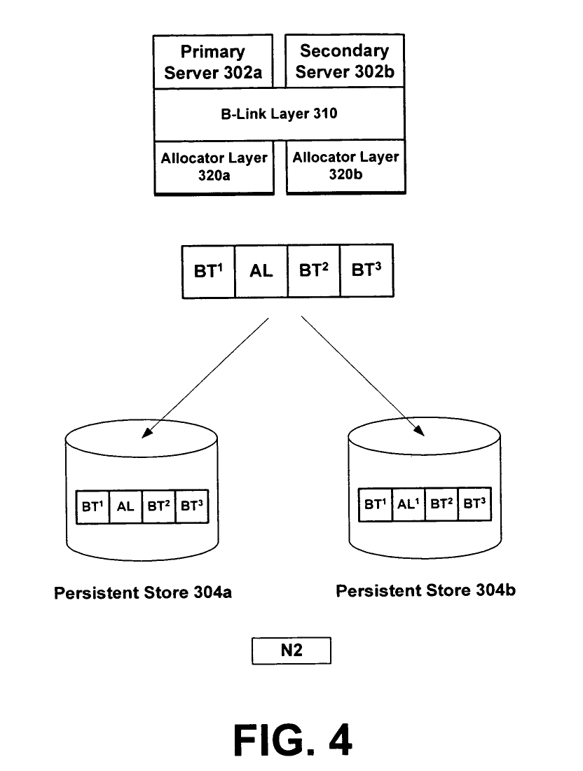

For simplicity, the data replication mechanism of the invention may be thought of as mirroring. An exemplary embodiment of the data replication of the invention is depicted in FIG. 4. Each B-link tree node, e.g., node N2, is maintained by both a primary server 302a and a secondary server 302b. Each operation on that B-link tree node is performed on both the primary and the secondary data stores 304a and 304b. B-link tree log entries are thus automatically replicated as the B-link tree is. The allocator log entries are specific to a server and are not replicated. Thus, the single log of the invention includes B-link tree transaction entries BT¹, BT² and BT³ generated by B-link tree layer 310, which are replicated to each of the stores 304a and 304b, but the allocator entries AL and AL¹ are specific to the allocation and deallocation of disk space by allocators 320a and 320b.

Advantageously, this embodiment of the invention provides that the allocator logs are local and the B-tree logs are distributed across multiple servers. Thus, the recovery of the system can be done by replaying the log entries stored locally to each server (which include both allocator log entries and B-tree log entries.)

There are multiple ways of implementing the present invention, e.g., an appropriate API, tool kit, driver code, operating system, control, standalone or downloadable software object, etc. which enables applications and services to log and recover updates in accordance with the invention. The invention contemplates the use of the invention from the standpoint of an API (or other software object), as well as from a software or hardware object that generates, accesses, retrieves or updates data for a distributed data structure. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to implement a distributed data structure. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices or storage units, such as databases. Therefore, the present invention should not be limited to any single embodiment, but rather should be construed in breadth and scope in accordance with the appended claims.

1. A method for logging while updating a B-link tree via a plurality of data transactions, whereby a current state of the data structure is recovered by re-performing data transactions represented by the logging, comprising:
generating at least one log entry corresponding to a data transaction of the plurality of data transactions, the data transaction to be carried out on said B-link tree; and
storing said at least one log entry into a log.

2. A method according to claim 1, further including periodically truncating the log.

3. A method according to claim 1, wherein said at least one log entry includes at least one of (A) at least one entry from an allocation layer and (B) at least one entry from a B-link tree layer.

4. A method according to claim 1, further including discarding said at least one log entry from the log when the data transaction has been carried out on said B-link tree.

5. A method according to claim 1, wherein said storing includes storing said at least one log entry into the log before the data transaction is carried out on said B-link tree.

6. A method according to claim 1, further including caching data of said data transaction before said data transaction is carried out on said B-link tree.

7. A method according to claim 1, further including storing said at least one log entry in an intermediate memory previous to storing said at least one log entry in the log.

8. A method according to claim 7, wherein said at least one log entry is moved from intermediate memory to the log after the data transaction commits.

9. A method according to claim 1, further including maintaining a log sequence number with each of said at least one log entry, uniquely identifying said at least one log entry.

10. A computer readable medium comprising computer executable instructions for performing the method of claim 1.

11. A modulated data signal carrying computer executable instructions for performing the method of claim 1.

12. A method for logging while updating a B-link tree via a plurality of data transactions, whereby a current state of the data structure is recovered by re-performing data transactions represented by the logging, comprising:
generating at least one log entry corresponding to a data transaction of the plurality of data transactions, the data transaction to be carried out on said B-link tree;
storing said at least one log entry into a finite log;
periodically flushing data corresponding to data transactions represented by the finite log to persistent storage; and
truncating said finite log in coordination with said flushing.

13. A method according to claim 12, wherein said at least one log entry includes at least one of (A) at least one entry from an allocation layer and (B) at least one entry from a B-link tree layer.

14. A method according to claim 12, further including discarding said at least one log entry from the finite log when the data transaction has been carried out on said B-link tree.

15. A method according to claim 12, wherein said storing includes storing said at least one log entry into the finite log before the data transaction is carried out on said B-link tree.

16. A method according to claim 1, further including caching data of said data transaction before said data transaction is carried out on said B-link tree.

17. A method according to claim 12, further including storing said at least one log entry in an intermediate memory previous to storing said at least one log entry in the finite log.

18. A method according to claim 17, wherein said at least one log entry is moved from intermediate memory to the finite log after the data transaction commits.

19. A method according to claim 12, further including maintaining a log sequence number with each of said at least one log entry, uniquely identifying said at least one log entry.

20. A computer readable medium comprising computer executable instructions for performing the method of claim 12.

21. A modulated data signal carrying computer executable instructions for performing the method of claim 12.

22. A method for logging while updating a data structure via a plurality of data transactions, whereby a current state of the data structure is recovered by re-performing data transactions represented by the logging, comprising:
replicating updates to the data structure to a first server location and a second server location;
generating at least one log entry corresponding to a data transaction of the plurality of data transactions, the data transaction to be carried out on said data structure; and
maintaining a single log, where the log is partitioned into an upper layer and an allocation layer, at each of said first and second server locations, wherein the single log includes log entries from both the upper layer and allocation layer.

23. A method according to claim 22, further including recovering the data structure after a failure by performing parallel recovery operations by each of said first and second server locations.

24. A method according to claim 22, wherein said data structure is a B-link tree.

25. A method according to claim 24, wherein the upper layer is a B-link tree layer that handles B-link tree operations.

26. A method according to claim 22, wherein the allocater layer handles at least one of (A) an allocate disk space operation, (B) a deallocate disk space operation, (C) a read from the allocated disk space operation and (D) a write to the allocated disk space operation.

27. A computer readable medium comprising computer executable instructions for performing the method of claim 22.

28. A modulated data signal carrying computer executable instructions for performing the method of claim 22.

29. A server for maintaining a log while updating a B-link tree via a plurality of data transactions, whereby a state of the data structure is recovered by re-performing data transactions represented by the logging, comprising:
a logging object that generates at least one log entry corresponding to a data transaction of the plurality of data transactions, the data transaction to be carried out on said B-link tree; and
a storage log for storing said at least one log entry.

30. A server according to claim 29, wherein the finite storage log including said at least one log entry is periodically truncated.

31. A server according to claim 29, further comprising:
an allocation layer object for said B-link tree; and
a B-link tree layer object,
wherein said at least one log entry includes at least one of (A) at least one entry from the allocation layer object and (B) at least one entry from the B-link tree layer object.

32. A server according to claim 29, wherein said at least one log entry is discarded from the storage log when the data transaction has been carried out on said B-link tree.

33. A server according to claim 29, wherein said at least one log entry is stored in the storage log before the data transaction is carried out on said B-link tree.

34. A server according to claim 29, wherein data of said data transaction is cached in a cache memory before said data transaction is carried out on said B-link tree.

35. A server according to claim 29, further including storing said at least one log entry in an intermediate memory previous to storing said at least one log entry in the storage log.

36. A server according to claim 35, wherein said at least one log entry is moved from intermediate memory to the storage log after the data transaction commits.

37. A server according to claim 29, wherein said logging object generates a log sequence number with each of said at least one log entry, uniquely identifying said at least one log entry.

38. A server for logging while updating a B-link tree via a plurality of data transactions, whereby a state of the data structure is recovered by re-performing data transactions represented by the logging, comprising:
a first object for generating at least one log entry corresponding to a data transaction of the plurality of data transactions, the data transaction to be carried out on said B-link tree;
a finite storage log for storing said at least one log entry;
a second object for periodically flushing data corresponding to data transactions represented by the at least one log entry in the finite storage log to persistent storage;
a third object for truncating said finite storage log in coordination with the operation of the flushing of the second object.

39. A server according to claim 38, further including:
an allocation layer and a B-link tree layer, wherein said at least one log entry includes at least one (A) at least one entry from the allocation layer and (B) at least one entry from the B-link tree layer.

40. A server according to claim 38, wherein said at least one log entry is discarded from the finite storage log when the data transaction has been carried out on said B-link tree.

41. A server according to claim 38, wherein said at least one log entry is stored in the finite storage log before the data transaction is carried out on said B-link tree.

42. A server according to claim 38, wherein data of said data transaction is cached in a cache memory before said data transaction is carried out on said B-link tree.

43. A server according to claim 38, further including storing said at least one log entry in an intermediate memory previous to storing said at least one log entry in the finite storage log.

44. A server according to claim 43, wherein said at least one log entry is moved from intermediate memory to the finite storage log after the data transaction commits.

45. A server according to claim 38, wherein said first object generates a log sequence number with each of said at least one log entry, uniquely identifying said at least one log entry.

46. A server for logging while updating a data structure via a plurality of data transactions, whereby a state of the data structure is recovered by re-performing data transactions represented by the logging, comprising:
a replication object that replicates updates to the data structure to a first server location and a second server location;
a logging object that generates at least one log entry corresponding to a data transaction of the plurality of data transactions, the data transaction to be carried out on said data structure; and
a storage element within which a single log is maintained, wherein the single log is partitioned into an upper layer and an allocation layer, at each of said first and second server locations, and wherein the single log includes log entries from both the upper layer and allocation layer.

47. A server according to claim 46, wherein the data structure is recovered after a failure via parallel recovery operations by each of said first and second server locations.

48. A server according to claim 46, wherein said data structure is a B-link tree.

49. A server according to claim 48, wherein the upper layer is a B-link tree layer that handles B-link tree operations.

50. A server according to claim 46, wherein the allocater layer handles at least one of (A) an allocate disk space operation, (B) a deallocate disk space operation, (C) a read from the allocated disk space operation and (D) a write to the allocated disk space operation.

51. A computing device for logging while updating a B-link tree via a plurality of data transactions, whereby a current state of the data structure is recovered by re-performing data transactions represented by the logging, comprising:
means for generating at least one log entry corresponding to a data transaction of the plurality of data transactions, the data transaction to be carried out on said B-link tree; and
means for storing said at least one log entry into a log.

52. A computing device according to claim 51, further including means for truncating the log periodically.

53. A computing device for logging while updating a B-link tree via a plurality of data transactions, whereby a current state of the data structure is recovered by re-performing data transactions represented by the logging, comprising:
means for generating at least one log entry corresponding to a data transaction of the plurality of data transactions, the data transaction to be carried out on said B-tree;
means for storing said at least one log entry into a finite log;
means for periodically flushing data corresponding to data transactions represented by the finite log to persistent storage; and
means for truncating said finite log in coordination with said means for periodically flushing.

54. A computing device according to claim 53, further including means for discarding said at least one log entry from the finite log when the data transaction has been carried out on said B-link tree.

55. A computing device for logging while updating a data structure via a plurality of data transactions, whereby a current state of the data structure is recovered by re-performing data transactions represented by the logging, comprising:
means for replicating updates to the data structure to a first server location and a second server location;
means for generating at least one log entry corresponding to a data transaction of the plurality of data transactions, the data transaction to be carried out on said data structure; and
means for maintaining a single log, where the log is partitioned into an upper layer and an allocation layer, at each of said first and second server locations, wherein the single log includes log entries from both the upper layer and allocation layer.

56. A computing device according to claim 55, wherein said data structure is recoverable after a failure by performing parallel recovery operations by each of said first and second server locations.
